(19) United States
(12) Patent Application Publication
(10) Pub. No.: US 2022/0281548 A1
(43) Pub. Date: Sep. 8, 2022

(54) Folding Hook Device

(71) Applicant: Illinois Grain & Seed, Inc., Cissna Park, IL (US)

(72) Inventors: Aaron Kaeb, Loda, IL (US); Dustin K. Kurtz, Paxton, IL (US)

(73) Assignee: Illinois Grain & Seed, Inc., Cissna Park, IL (US)

(21) Appl. No.: 17/652,185

(22) Filed: Feb. 23, 2022

Related U.S. Application Data
(60) Provisional application No. 63/200,405, filed on Mar. 5, 2021.

(51) Int. Cl. B62J 25/06; E06C 9/04

(52) U.S. Cl. CPC B62J 25/06; E06C 9/04

(57) ABSTRACT

A folding hook device with an elongated arm folds vertically from a support bracket. The elongated arm is vertically supported in a horizontal orientation by a protrusion. The protrusion extends from a pivot portion disposed on a side of the elongated arm opposite a hook end. The protrusion has a first abutment face. The support bracket has a second abutment face. The second abutment face cooperates with the first abutment face to limit rotation of the elongated arm. A method of using the device includes mounting the device on a vertical surface, such as a body of a golfcart. The elongated arm is pivoted into a horizontal orientation. An object may hang, rest, or be supported by the device when deployed in the horizontal orientation. The elongated arm is stowed by pivoting the elongated arm into a vertical orientation.

### CROSS REFERENCES

This application claims priority of U.S. Provisional Application No. 63/200,405 filed 5 Mar. 2021.

### FIELD OF THE INVENTION

The present disclosure relates to a folding hook device and associated method to employ the device in a horizontal orientation and stow the device in a vertical orientation. The device is designed to be rigidly mounted to a vehicle, or other vertical structure. The device may be used to hold, mount, or act as a foot-rest, leg-rest, or function as a ladder attachable to vertical structures scaled by climbing.

### BACKGROUND

Hooks are used in applications such as hanging fixtures. Such devices may be easily deployable when they are needed and stowed when they are not needed to stay out of the way when not in use. Such devices may be made from lightweight materials and constructed of a durable design. Many items or articles may be supported by hook or peg devices such as shopping bags, handbags, feet, etc.

Foot pegs are used for resting feet when riding motorcycles. Especially on long trips, riders in a reclined riding position desire to prop their feet on such devices. The pegs used as a footrest provide forward support of the feet and legs as the rider reclines. Resting the feet on pegs can help blood circulation in the legs and change the pressure points in the seat so that the rider can go further with more comfort between stops. Such pegs may be bulky, heavy, and made of materials that do not compliment their use in other applications.

### SUMMARY

A folding hook device is disclosed having an elongated arm with a pivot portion. The pivot portion contains a pivot point upon which the elongated arm pivots between a vertical orientation and a horizontal orientation. The elongated arm has a hook end that is distal to the pivot portion. The hook end has a hook member. A protrusion extending from the pivot portion is disposed on a side of the elongated arm opposite the hook member. The protrusion has a first surface, hereinafter referred to as a first abutment face, that is flat. A support bracket, upon which the elongated arm is pivotally mounted at the pivot point, has a second abutment face that is flat. The second abutment face abuts the first abutment face to limit rotation of the elongated arm about the pivot point thereby providing vertical support to the hook end of the elongated arm.

The folding hook device may optionally have other elements. A resting plate that is flat may extend between the pivot portion and the hook end. The resting plate may be smooth. The first abutment face may at most be perpendicular to the resting plate. The first abutment face may be smooth. The support bracket may have a first plate, a second plate, a cross plate connected between the first plate and the second plate, and an aperture disposed between the first plate and the second plate. The aperture may receive the protrusion when the elongated arm is in the horizontal orientation. The protrusion may be located at a pivot portion of the elongated arm to limit rotation of the elongated arm. The protrusion may provide lateral support of the elongated arm when providing vertical support for the hook end of the elongated arm. The elongated arm may be pivotally mounted to the support bracket between the first plate and the second plate. The elongated arm may pivot through a pivot plane that is perpendicular to the resting plate. The hook member may extend upwardly from the hook end of the elongated when the elongated arm is in the horizontal orientation. A width of the hook member may be at least the width of the elongated arm. The elongated arm may have a cam member extending from the pivot portion. The cam member may be disposed across from the hook member on a same side of the elongated arm. The cam member may have a third abutment face that is curved and smooth. The third abutment face may have at most ninety degrees of curvature. The third abutment face may abut the second abutment face thereby providing rotational pressure to the elongated arm. The third abutment face may pressurize rotational pressure on the pivot portion when the elongated arm is in the horizontal orientation. The third abutment face may release rotational pressure on the pivot portion when the elongated arm is in the vertical orientation. The second abutment face may be smooth and at most perpendicular to the pivot plane of the elongated arm. The second abutment face may be disposed on the cross plate. The cross plate may cooperate with the first abutment face to limit rotation of the elongated arm in the horizontal orientation. The protrusion may comprise a notch disposed in the first abutment face of the protrusion. The notch may receive the cross plate when the elongated arm is in the horizontal orientation. A curvature of the elongated arm may be generally S-shaped where the protrusion has an inverse orientation to the hook member. The pivot point may be generally disposed at a foot of a right angle formed between lines extending from the hook end of the elongated arm and a bottom end of the protrusion towards the pivot point.

A method of using the folding hook device has the following steps: (1) mounting a folding hook device; (2) pivoting an elongated arm of the folding hook device into a horizontal orientation; and (3) stowing the elongated arm into a closed position by pivoting the elongated arm about a pivot point to reduce a distance that the folding hook device extends out.

The method of using the folding hook device may optionally have the following steps: (1) mounting a folding hook device to a body of a vehicle, such as a front roof support, a fender, or a frame of a golfcart; (2) extending a hook member upwardly from the hook end of the elongated arm when in the horizontal position; (3) hanging an object on the folding hook device; (2) providing a horizontal surface on the resting plate of the folding hook device for hanging, resting, or supporting an object; (4) mounting the folding hook device to a vertical surface or utility pole; (5) providing a horizontal surface on the resting plate of the folding hook device for vertical ascension or descension; (6) supporting an object that rests on or hangs from the elongated arm of the device; (7) locking the pivot portion of the elongated arm into a vertical or horizontal orientation to allow or inhibit use as a vertical ascension device; (8) pressurizing or releasing the force between the abutment faces during rotational motion by the elongated arm; (9) supporting the elongated arm vertically with cooperation of the abutment faces of the support bracket and the elongated arm; (10) stowing the elongated arm in a vertical orientation to limit obstruction by the device extending out from a surface; (11) deploying the elongated arm of the device by pushing the protrusion extending out from the support bracket when the elongated arm is in a vertical orientation; (13) stowing the elongated arm of the device by pushing or pulling up on the elongated arm when the elongated arm is in a horizontal orientation; and (13) inserting the elongated arm through a slot of an object, where upon insertion the elongated arm of folding hook device is stowed in a vertical orientation to reduce the distance between the object and the mounting surface of the folding hook device.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 shows a side-perspective, exploded view of a folding hook device;

FIG. 2 shows a side view of a folding hook device, in a horizontal orientation, having a first plate removed;

FIG. 3 shows a side view of a folding hook device, in a vertical orientation, having the first plate removed; and

FIG. 4 shows a flowchart for a method of use for a folding hook device.

### DETAILED DESCRIPTION

A folding hook device is provided that comprises an elongated arm that folds vertically from a support bracket such that the elongated arm is vertically supported when in a horizontal orientation. The elongated arm of the folding hook device may provide a surface for hanging, resting, or supporting an object. The elongated arm of the folding hook device may be used to support the weight of a person when used as a footstep or peg. The folding hook device may be used in scenarios where the device is used in a confined space or an open space where stowing of the elongated arm decreases the device from becoming an obstruction. The folding hook device may be mounted on surfaces for hanging or resting an object. The folding hook device may vertically support the weight of an object when the elongated arm is in a generally horizontal orientation. The folding hook device allows for use of the elongated arm in an open or deployed configuration and for storage in a closed or stowed configuration. The folding hook device stows into a compact device that can easily deployed for use in varied applications. The core components of the folding hook device are a pivot portion, a resting plate, a hook end, a protrusion, a cam member, and abutment faces on the elongated arm and support bracket that cooperate together to provide object support and rotational function.

The core components are generally configured in a manner as outlined in the disclosure. The elongated arm is generally disposed between the hook end and the pivot portion. The elongated arm may have a resting plate that is generally flat and smooth. On either side of the pivot portion may be the cam member and the protrusion. The pivot portion may be disposed between the cam member and the protrusion. The cam member, the pivot portion, and the protrusion cooperate with the support bracket and may cooperate through an interaction by contact of abutment faces to providing vertical support or rotational affects when the folding hook device is employed in, or between, a deployed or stowed configuration.

With respect to the device, a method of hanging, resting, or supporting an object is provided. With respect to the associated methods, in general, to carry out the method the following core steps are followed: mounting the folding hook device to a surface; pivoting the elongated arm of the folding hook device into a deployed configuration when in use; stowing the elongated arm of the folding hook device into a stowed configuration when not in use. Ultimately, at the conclusion of these steps a distance by which the elongated arm extends out has been minimized to reduce the amount of obstruction to the space where the device is used.

The folding hook device provides a simply and cheaply made device that transfers the force from the weight of an object. The force applied downward on the elongated arm of the device transfers the weight force from the object through the elongated arm to the support bracket. The support bracket in return applies the transferred force back through the elongated arm to vertically support the weight of the object. This interaction between the object and the folding hook device may provide for a functional and easier way to support an object with less parts. Furthermore, the folding hook device may have bilateral symmetry, so components of the device may allow for manufacture of one set of parts that may be used in either a left-hand configuration or in a right-hand configuration. The folding hook device may provide for means of controlling rotation of the elongated arm into a chosen orientation by a cam member. The cam member provides rotational pressure between the pivot portion of the elongated arm and the abutment face of the support bracket to retain the elongated arm in a deployed configuration. The design of the cam member may also free the elongated arm to stay in a vertical orientation. The folding hook device may provide a footrest that is a durable and stable surface outside the body of a golfcart for a driver or passenger to extend and rest their foot. The folding hook device may provide a support surface that is a cheap and functional way to hang an object, such as a grocery sack, purse, or other bag on the body of a golfcart. The folding hook device may be made more robustly to provide a footstep for climbing vertical structures. Similarly, the footstep may have an associated method that provides means for locking the folding hook device in such applications to prevent trespass. Therefore, design variations in the structure or materials used for the folding hook device may be employed to meet the intended use.

Disclosed is a folding hook device, which is made up of the following components: (1) an elongated arm having a first side, second side, first end face, second end face, top and bottom, with the first and second sides having bilateral symmetry, the first and second end faces being generally flat with a curved transition to the top and bottom, the top side being generally flat with curved ends, and the bottom side curving into a projection or protrusion on one end; and (2) a support bracket having a first plate, second plate, and cross plate, with the first plate and second plate being parallel. An aperture is disposed between the first plate and the second plate and has at least a width equal to that of the elongated arm, and the cross plate ends being connected between the first and second plates, which are perpendicular to the cross plate, to form a flat abutment face that cooperates with a flat abutment end of the elongated arm to vertically support the elongated arm. These components are connected by a pivot pin that slides through a pivot opening in the support bracket and through a pivot point on the elongated arm. The connection allows the elongated arm to have rotational motion along a vertical plane while the support bracket remains stationary. Also disclosed is a method of use for the folding hook device, which includes the following steps: (1) mounting the folding hook device on a body of a vehicle such as a golfcart or a vertical surface; and (2) pivoting the elongated arm of the folding hook device into a horizontal orientation to hang, rest, or support an object, with the elongated arm being limited in rotation by a flat abutment face on the protrusion extending from a bottom side of the elongated arm to cooperate with a flat abutment face on the support bracket. The steps are related by providing a sturdy surface that allows the support bracket to maintain a stationary position in relation to the structure mounted to while the elongated arm may be moved through a vertical rotation about a pivot plane.

The folding hook device may also have one or more of the following: (1) a hook member connected at the edge of the hook end allowing an object to be retained from slipping off the hook end; (2) a cam member connected to the pivot portion of the elongated arm allowing the smooth rotation, with or without pressure, between the abutment faces of the elongated arm and the support bracket; (3) a notch disposed in an end face of the elongated arm or the abutment face of the protrusion, receiving a cross plate that may be disposed between the first and second plates of the support bracket; (4) a fastener opening(s) on the cross plate or the first and second plates of the support bracket for mounting; (5) a bolt or rod fastener(s) to pass through the fastener opening(s) securing the support bracket in a stationary position in relation to the surface mounted; (6) a webbed or I-beam shaped cross section giving structural support for applications where the device is manufactured from less durable materials; and (7) a resting plate on the top side of the elongated arm providing a surface for resting, hanging, or vertical support to an object.

Similarly, the associated method may also include one or more of the following steps: (1) extending a hook member upwardly from the hook end of the elongated arm when in the horizontal position; (2) mounting the folding hook device to a vehicle's front roof support, fender, or frame thereby providing a horizontal surface for hanging, resting, or supporting an object; (3) mounting the folding hook device to a vertical surface or utility pole thereby providing a horizontal surface for vertical ascension or descension or supporting an object that rests on or hangs from the elongated arm of the device; (4) locking the pivot portion of the elongated arm into a vertical or horizontal orientation to allow or inhibit use as a vertical ascension device; (5) pressurizing or releasing the force between the abutment faces during positions of rotational motion by the elongated arm; (6) supporting the elongated arm vertically through cooperation of the abutment faces of the support bracket and the elongated arm; (7) stowing the elongated arm in a vertical orientation to limit obstruction by the device extending out form a surface; (8) engaging the elongated arm of the device by pushing the protrusion extending out from the support bracket when the elongated arm is in a vertical orientation; and (9) inserting the elongated arm through a slot of an object, which in rotating the elongated arm of folding hook device in a vertical orientation reduces the distance between the object and the mounting surface thereby clamping the object and the mounting surface together.

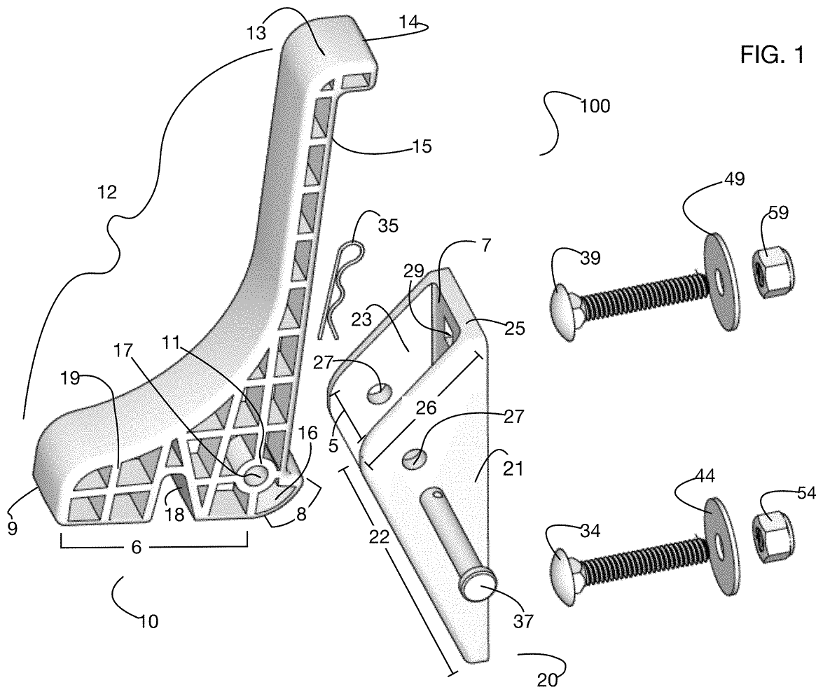

Referring now to FIG. 1, a drawing is shown illustrating a side perspective view of an exploded assembly of a complete version of the folding hook device 100. By way of example, the folding hook device 100 may be made of plastic, such as low- or high-density polyethylene, polytetrafluorethylene, or ultra-high molecular weight polyethylene, polyvinyl chloride (PVC), or metals, such as aluminum, zinc, copper, brass, iron, stainless steel, or other material that provides a hard and durable device that is resistant to impact, chemical(s), abrasion(s), thermal fluctuation(s), ultraviolet light, weathering, and/or moisture. The folding hook device 100 may be manufactured by injection molding to conserve the amount of material resources used. A mold of the parts of folding hook device 100 may be crafted from stainless steel or aluminum. The mold may be injected with a liquid phase of plastic polymers or metal materials at high temperatures and/or under extreme pressure. The mold is then cooled to release the parts of folding hook device 100. Alternatively, the folding hook device 100 may be manufactured from a block of material and formed using a Computerized Numerical Control (CNC) machine, gas-assisted injection molding, multi-component injection molding, foam injection molding, blow molding, compression molding, or other manufacturing techniques.

As shown in FIG. 1, the folding hook device 100 includes an elongated arm 10 that is flat and smooth having an outside width that is the same. Alternatively, the elongated arm 10 may be sloped, angled, tapered, or comprise a rod or bar structure. In particular, the elongated arm 10 of FIG. 1 may at its widest section have a width range of approximately 0.5 inches to 2.5 inches and at its longest section a length range of approximately 3 inches to 15 inches. The elongated arm 10 in the horizontal orientation may from top to bottom, at its greatest height, have a height range of approximately 1.5 inches to 7.5 inches. The elongated arm 10 may have an I-beam type cross section with an inner, solid wall positioned medially between a first side and a second side of the elongated arm 10. The inner, solid wall may provide structural stability of the elongated arm 10. Alternatively, or in combination with the I-beam design, webbing in the form of trusses may intersect across the first side and the second side from a first edge of the elongated arm 10 to a second edge of the elongated arm 10 to further enhance structural support.

A resting plate 15 that may have a flat and smooth surface is formed on a top side of the elongated arm 10. The resting plate 15 may at its widest section have a width range of approximately 0.5 inches to 2.5 inches and at its longest section a length range of approximately 3 inches to 14.75 inches. The resting plate 15 in the horizontal orientation may from top to bottom, at its greatest height, have a height range of approximately 1.5 inches to 7 inches. The resting plate 15 in the horizontal orientation may from top to bottom, at its least height, have a height range of approximately 0.25 inches to 1 inch. The resting plate 15 may include a hook member 14 that is on one end or the elongated arm 10 or hook end 13.

The hook end 13 may include a hook member 14 that extends upwardly from the resting plate 15 when the elongated arm 10 is in an open, deployed, or horizontal orientation. The hook member 14 may at its widest section have a width range of approximately 0.5 inches to 2.5 inches. The hook member 14, when in the horizontal orientation, may from top to bottom, at its greatest height, have a height range of approximately 0.5 inches to 2.5 inches.

Going now around the hook member 14, past an end face of the hook end 13 to a bottom side of the elongated arm 10, a concave portion is formed after a generally flat portion of the bottom side of the elongated arm 10. The concave portion generally forms an intrados shape that resembles the lower or inner curve of an arch. As discussed previously, the first side and the second side of the elongated arm 10 may have a truss design formed from injection molding. The truss design may cooperate with the intrados shape of the lower or inner curve of the arch to provide structural support to the elongated arm 10 when supporting an object. In particular, the arc formed by the concave portion of FIG. 1, may have a radius range of approximately 0.5 inches to 2.5 inches. Additionally, the concave portion in relation with the flat portion or bottom side of the elongated arm 10 and the end face of the hook member 14 forms a generally S-shaped curve 12. Not wanting to be bound to a theory, the S-shaped curve 12 may provide vertical support to an object pushing, resting, or hanging on the resting plate 15. The weight of the force of the object pushing, resting, or hanging on the resting plate 15 may be transferred down along the S-shaped curve 12 of the elongated arm 10 and be absorbed and dispersed by the concave portion into the opposing end of the elongated arm 10.

Now moving past the concave portion, a bottom end 9 of a protrusion 19 having a generally flat and smooth surface being parallel with the resting plate 15 on an opposing side of the elongated arm 10 is located. The bottom end 9 of the protrusion 19 is adjacent to a first abutment face 6 of the protrusion 19 that is flat and smooth. The first abutment face 6 being generally parallel, in some cases, with the end face of the hook end 13 on an opposing side of the elongated arm 10 is located. The first abutment face 6 may be perpendicular to the surface of the resting plate 15 where the first abutment face 6 is parallel with the outside end face of the hook member 14. Alternatively, a bottom portion of the first abutment face 6 may be canted towards the outside end face of the hook member 14 forming an angle that is less than perpendicular with the surface of the resting plate 15. In this case, the top portion of the first abutment face 6 extends upwardly along the protrusion 19 towards a plane formed by the resting plate 15 and is canted away from the outside end face of the hook member 14. In particular, the angle presented that is less than perpendicular may at its greatest range be approximately 85 degrees to 90 degrees, and more particularly be between 88 degrees to 86 degrees, and most preferably at approximately 88 degrees. The canted angle may compensate for mounting to a vertical surface to that is not perpendicular with the horizontal ground surface.

The first abutment face 6 of the protrusion 19 may also contain a hollow or notch 18 that extends into the protrusion 19. In terms of describing the shape of the notch 18, in relation to the elongated arm 10 being in a horizontal orientation, the bottom portion of the notch 18 flat and parallel to a plane formed by the resting plate 15. The top portion of the notch 18 is canted at an angle from parallel. The canted angle provides a notch opening that is greater in size than that opening that extends into the protrusion 19. The notch 18 may receive a second cross plate 28 of the support bracket 20. The surface of the notch 18 and the second cross plate 28 may, or may not, be in contact when the elongated arm 10 is in the deployed configuration. The notch 18 cooperates with the second cross plate 28 to fit together when engaged and allows smooth transition when disengaged as the elongated arm 10 is placed into a vertical position. In particular, the notch 18 of FIG. 1, may extend into the protrusion 19 at a distance range of approximately 0.25 inches to 1.25 inches. The notch 18 may have a slot or opening thickness range of approximately 0.1 inches to 1.25 inches. The first abutment face 6 extends above the notch 18 and transitions into a third abutment face 8.

The third abutment face 8 is convexly curved and smooth and is the surface of a cam member 16 of the elongated arm 10. In particular, the arc formed by the cam member 16 of FIG. 1, may have a radius range of approximately 0.25 inches to 2.5 inches. Once a measure of the arc angle of the cam member 16 reaches approximately 90 degrees, the surface of the cam member 16 transitions with a tapered edge down towards the resting plate 15. The third abutment face 8 of the cam member 16 cooperates with a first cross plate 25 of the support bracket 20 or, alternatively, a surface the elongated arm 10 is pivotally mounted to. The third abutment face 8 allows for pressure to be made as contact between the cam member 16 and the first cross plate 25 occurs. This may force the elongated arm 10 to maintain a horizontal orientation when in the deployed configuration. The third abutment face 8 also allows for pressure to be released as contact between the cam member 16 and the first cross plate 25 disengages. This may allow the elongated arm 10 to be free to maintain a vertical orientation when in the stowed configuration. The elongated arm 10 held in this position may have an approximate range of free movement from vertical between 0 degrees to 5 degrees.

A portion of the cam member 16 and the protrusion 19 make a pivot portion 11 of the elongated arm 10. The pivot portion 11 is generally across from the hook end 13 of the elongated arm 10. The pivot portion 11 contains an opening or pivot point 17. The pivot point 17 is disposed through the elongated arm 10. The pivot point 17 may be generally located within the pivot portion 11 at a foot of a right angle formed by lines extending from the hook end 13 and the bottom end 9 of the protrusion 19 towards the pivot point 17. In particular, a center of the pivot point 17 as shown in FIG. 1, may be located at a distance range of approximately 0.25 inches to 2.5 inches from an outside arc surface of the cam member 16. The pivot point 17 allows for insertion of a bolt, bar, rod or pivot pin 37 through the support bracket 20 and elongated arm 10 allowing for pivotal rotation of the elongated arm 10 within the support bracket 20. The pivot pin 37 may be made of similar materials as used for the elongated arm 10 as previously discussed. The pivot pin 37 may include a lock pin 35 such as a cotter pin, latch, or key to prevent the pivot pin 37 from being unintentionally removed.

As shown in FIG. 1, the support bracket 20 is detached from the elongated arm 10. The support bracket 20 may also be manufactured by injection molding to conserve the amount of material resources used. The support bracket 20 may be made of similar or different materials than that described for the elongated arm 10. The support bracket 20 may have a first plate 21 and a second plate 23. The first plate 21 and the second plate 23 may have a first pivot opening 27. The purpose of the first pivot opening 27 may be to receive the pivot pin 37. A first cross plate 25 may be disposed and connected between the first plate 21 and the second plate 23. The first cross plate 25 may be disposed and connected to a back edge of the first plate 21 and second plate 23. An aperture 5 may be disposed between the first plate 21 and the second plate 23. The aperture 5 may receive the protrusion 19 when the elongated arm is in the horizontal orientation. The aperture 5 may be disposed between the first plate 21 and the second plate 23. The aperture 5 may have at least a width equal to that of the elongated arm 10. A back side and a front side of the first cross plate 25 may be flat and smooth. The front side of the cross plate 25 may form the first abutment face 6 that cooperates with the second abutment face 7 of the elongated arm 10 to vertically support the elongated arm 10. The back side of the first cross plate 25 may have a curvilinear or curved face for conformance to a surface mounted to, such as a curved fender of a golfcart. Alternatively, or in combination, a second cross plate 28 may be disposed and connected between the first plate 21 and the second plate 23. The first cross plate 25 and the second cross plate 28 may be perpendicular. The first cross plate 25 and the second cross plate 28 may provide structural support to the first plate 21 and the second plate 23. The second cross plate 28, when disposed horizontally and perpendicular to the first cross plate 25 may provide sidewall support to the first plate 21 and the second plate 23 when pressure is applied to the elongated arm 10. The front side of the first cross plate 25 may provide a second abutment face 7. The second abutment face 7 may cooperate or abut with the first abutment face 6. A front edge of the first plate 21 and the second plate 23 may also be flat and smooth. Alternatively, the back edge of the first plate 21 and the second plate 23 may be angled for conformance to a shape that cooperates with the first cross plate 25. The front edge of the first plate 21 and the second plate 23 may also be angled to conform to a shape that matches with a side profile of the protrusion 19 of the elongated arm 10. In the example shown in FIG. 1, the front edges of the first plate 21 and the second plate 23 may form a substantially obtuse angle about the first pivot opening 27 before joining with the first cross plate 25. A first bracket edge 22 of the support bracket 20 may be longer or shorter than a second bracket edge 26 of the support bracket 20. Additionally, a first fastener opening 24 and a second fastener opening 29 may be disposed through the first cross plate 25 to allow for fastening to a surface.

As shown in FIG. 1, a plurality of mounting supports and fasteners may be used for attaching the support bracket 20 to a surface. In the example shown, bolts are used as a first support bar 34 and a second support bar 39 that may be inserted through the first fastener opening 24 and the second fastener opening 29 to attach the support bracket 20 to a substantially vertical surface. Upon insertion through the fastener openings, the first support bar 34 and the second support bar 39 may be inserted through a first load distributor 44 and a second load distributor 49, such as washers. The first load distributor 44 and the second load distributor 49 may serve as a spacer between the support bracket 20 and the surface attached to. Additionally, the first load distributor 44 and the second load distributor 49 may serve to spread the pressure on the support bracket 20 caused by tightening of a first fastener 54 and a second fastener 59 to join the back side of the first cross plate 25 to a surface.

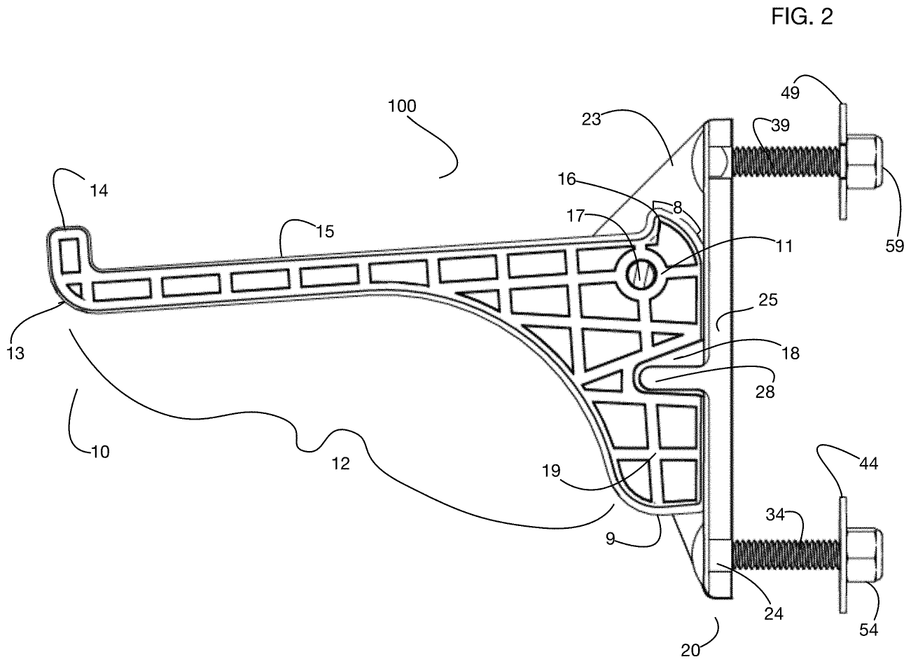

Referring now to FIG. 2, the folding hook device 100 is shown in the horizontal orientation with the first plate 21 removed to show the interaction between the first abutment face 6 and the second abutment face 7. The first abutment face 6 cooperates with the second abutment face 7 of the support bracket 20 when in contact. The surfaces of the abutment faces may be flat and smooth. The abutment faces may come fully into contact when the elongated arm 10 is in the horizontal orientation. Not wanting to be bound to a theory, the pressure applied to the elongated arm 10 by an object may be distributed over the surface of the front side of the first cross plate 25 and/or the second cross plate 28 of the support bracket.

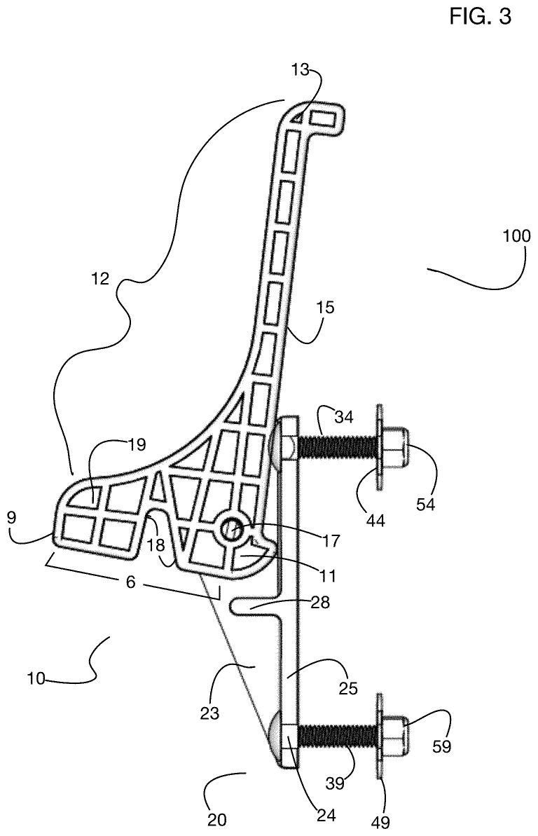

Referring now to FIG. 3, the folding hook device 100 is shown in the vertical orientation with the first plate 21 removed to show the interaction between the second abutment face 7 and the third abutment face 8. The surface of the second abutment face 7 may be flat and smooth. The surface of the third abutment face 8 may be curved and smooth. The abutment faces may come into contact as the elongated arm 10 is rotated from the horizontal orientation to the vertical orientation and vice versa. The third abutment face 8 may cooperate with the second abutment face 7 of the support bracket 20 to apply pressure between the elongated arm 10 and the support bracket 20 when in contact. Not wanting to be bound to a theory, the pressure applied through the third abutment face 8 of the cam member 16 as the elongated arm 10 is being deployed or stowed may be distributed to the second abutment face 7 of the first cross plate 25. The pressure between the cam member 16 and the first cross plate 25 may allow the elongated arm 10 to maintain a horizontal position when in a deployed configuration. Inversely, as shown in FIG. 3, the pressure between the first abutment face 6 of the cam member 16 and the second abutment face 7 of the first cross plate 25 may allow the elongated arm 10 to maintain a stowed configuration when the elongated arm 10 is placed into the vertical orientation. The elongated arm 10, when stowed in the vertical orientation, may range past vertical between 0 degrees to 5 degrees.

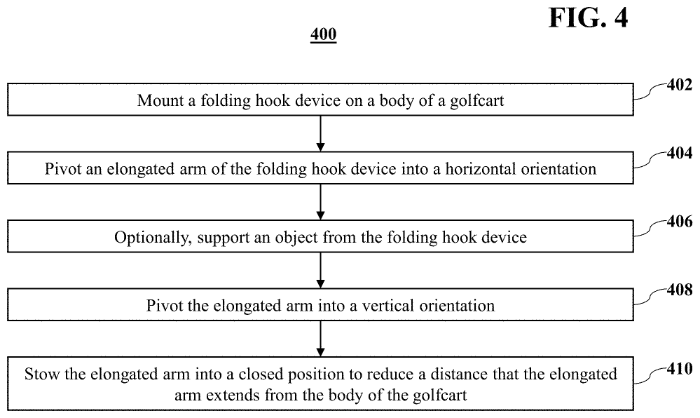

Referring now to FIG. 4, a method 400 of use for the folding hook device is disclosed. The method 400 includes: (1) mounting a folding hook device 100 on a body of a vehicle, such as a golfcart, according to step 402; (2) pivoting an elongated arm 10 of the folding hook device 100 into a horizontal orientation, according to step 404; (3) optionally, hanging or resting an object, such as a foot or leg, on the elongated arm 10 of the folding hook device 100, according to step 406; (4) optionally, pivoting the elongated arm into a vertical orientation, according to step 408; and (5) stowing the elongated arm into a closed position by pivoting the elongated arm about a pivot point to reduce a distance that the folding hook device extends out from the body of the golfcart, according to step 410.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A folding hook device comprising:
a. an elongated arm comprising:
i. a pivot portion comprising:
1. a pivot point upon which the elongated arm pivots between a stowed configuration and a deployed configuration;
ii. a hook end, distal to the pivot portion, comprising:
1. a hook member;
iii. a protrusion extending perpendicular to a length of the elongated arm from the pivot portion and disposed on a side of the elongated arm opposite the hook member, the protrusion comprising:
1. a first abutment face; and
b. a support bracket upon which the elongated arm is pivotally mounted at the pivot point, the support bracket comprising:
i. a second abutment face and the second abutment face abuts the first abutment face in a vertical plane in the deployed configuration to limit rotation of the elongated arm about the pivot point thereby providing vertical support to the hook end of the elongated arm.

2. The folding hook device of claim 1, further comprising:
a. a resting plate extending between the pivot portion and the hook end; and
b. wherein the first abutment face is at most perpendicular to the resting plate.

3. The folding hook device of claim 1, wherein the support bracket comprises:
a. a first plate;
b. a second plate;
c. a cross plate connected between the first plate and the second plate; and
d. an aperture disposed between the first plate and the second plate receives the protrusion when the elongated arm is in the deployed configuration.

4. The folding hook device of claim 3, wherein the second abutment face is disposed on the cross plate.

5. The folding hook device of claim 3, wherein the cross plate cooperates with the first abutment face to limit rotation of the elongated arm in the deployed configuration.

6. The folding hook device of claim 3, wherein the protrusion further comprises:
a. a notch disposed in the first abutment face, the notch receives the cross plate when the elongated arm is in the deployed configuration.

7. The folding hook device of claim 1, wherein the elongated arm further comprises:
a. a cam member extending from the pivot portion and disposed across from the hook member on a same side of the elongated arm, the cam member comprising:
i. a third abutment face that is curved and the third abutment face abuts the second abutment face thereby providing rotational pressure to the elongated arm.

8. The folding hook device of claim 1, wherein the elongated arm is generally S-shaped and in a deployed configuration the protrusion extends downward from the elongated arm and the hook member extends upward from the elongated arm.

9. The folding hook device of claim 1, wherein the pivot point is generally disposed at a foot of a right angle formed between a first line extending along the length of the elongated arm towards the pivot point and a second line extending from a bottom end of the protrusion towards the pivot point.

10. A method of selectively deploying a folding hook device upon a golfcart comprising the steps of:
a. mounting a support bracket on a body of the golfcart;
b. pivoting an elongated arm mounted to the support bracket about a pivot point from a stowed configuration, wherein the elongated arm has a protrusion extending perpendicular to a length of the elongated arm from a pivot portion, the protrusion disposed on a side of the elongated arm opposite a hook member;
c. limiting rotation of the elongated arm about the pivot point in a deployed configuration, wherein a first abutment face of the protrusion provides vertical support to a hook end of the elongated arm when the first abutment face abuts a second abutment face of the support bracket in a vertical plane; and
d. stowing the elongated arm in the stowed configuration by pivoting the elongated arm about the pivot point to reduce a distance that the elongated arm extends from the body of the golfcart.

11. The method of claim 10, wherein the protrusion extends downward from the pivot portion of the elongated arm in the deployed configuration.

12. The method of claim 11, wherein the hook member extends upward from the hook end of the elongated arm in the deployed configuration.

13. The method of claim 11, wherein the folding hook device is mounted to a fender of the golfcart.

14. The method of claim 11, wherein the folding hook device is mounted to a frame of the golfcart.

15. The method of claim 10, wherein the folding hook device is mounted to a front roof support of the golfcart.

16. A folding hook device comprising:
a. an elongated arm comprising:
i. a pivot portion, comprising:
1. a pivot point;
ii. a hook end, distal to the pivot portion, comprising:
1. a hook member;
iii. a resting plate extending between the pivot portion and the hook end;
iv. a protrusion, proximal to the pivot portion, extending downward from a bottom side of the elongated arm opposite the hook member when the elongated arm is in a horizontal orientation, the protrusion comprising:
1. a first abutment face;
b. a support bracket upon which the elongated arm is pivotally mounted at the pivot point such that the first abutment face of the protrusion abuts the support bracket in a vertical plane to limit rotation of the elongated arm about the pivot point thereby providing vertical support to the hook end of the elongated arm; and
c. wherein the elongated arm pivots through a pivot plane that is perpendicular to the resting plate.

17. The folding hook device of claim 16, wherein the elongated arm further comprises:
a. a cam member extending from the pivot portion and disposed across from the hook member on a same side of the elongated arm, the cam member comprising:
i. a third abutment face having at most ninety degrees of curvature releases rotational pressure on the pivot portion when the elongated arm is in a vertical orientation.

18. The folding hook device of claim 16, wherein the support bracket comprises:
a. a second abutment face that is perpendicular to the pivot plane.
